(19) United States
(12) Patent Application Publication
(10) Pub. No.: US 2012/0232692 A1
(43) Pub. Date: Sep. 13, 2012

(54) LOCAL ACCESS DELIVERY CONTROL SYSTEM

(76) Inventors: Jane Win-Shih LIU, Taipei (TW); Tsung-Yen Chen, Kaohsiung City (TW); Yen-Ting Chuang, Taipei County (TW); Hung-Che Lin, Taipei County (TW)

(21) Appl. No.: 13/344,875

(22) Filed: Jan. 6, 2012

(30) Foreign Application Priority Data
Mar. 11, 2011 (TW) 100108432

(51) Int. Cl. G06F 17/00

(52) U.S. Cl. 700/236; 700/237

(57) ABSTRACT

The patent disclose a multi-user local access and delivery control system which comprises at least one storage device including a plurality of controlled storage cavities and a plurality of mobile units, each comprising a plurality of lockable storage drawers and an ID information pickup device. Particular storage cavities and storage drawers are unlocked to allow a deliverer to remove items from the storage cavities and place them in the storage drawers. After being relocked, the storage drawers are unlocked only when designated receivers are identified.

### FIELD OF THE INVENTION

The present invention relates to a local access and delivery control system, especially to an automated system that controls the access and delivery of controlled resources in a hospital, factory, community or other local areas, in order to ensure the correctness and safety of the access and delivery.

### BACKGROUND OF THE INVENTION

The concept of using the strong operation capability of a computer system to manage the access and delivery of articles (i.e., items) in a local area has been well-accepted in all industries. For example, in a factory a great variety of materials, components, assemblies, finished products and half-finished products needs to be managed. In addition, the production, consumption and procurement quantities of materials, components, assemblies, finished products and half-finished products change all the times. It is almost impossible to manage and control the access and delivery of these resources without the help of a computer system and computerized tools. For this reason, computerized resource management systems for access and delivery of resources have become necessary for all factories.

In addition to factories, communities, organizations, governmental agencies and private institutions need to use computerized resource management systems to manage the resources they procured or produced. In response to such needs, many have developed computerized resource management systems. Resources management systems already developed and commercially available are often called intelligent systems and provide functions such as inventory management, dispensing control and procurement suggestion.

In an organization such as a hospital, the resources to be managed include medications and medical supplies that are expensive and health impacting. In other organizations, the computerized management of the resources that are costly, controlled by law and hazardous to health is also necessary. In such cases, in addition to the management capabilities, the resource management system needs to provide the monitoring functions.

U.S. Pat. No. 7,467,093 discloses a method of tracking and dispensing medical items to patients through self-service delivery system. The system comprises a medical item dispensing system and a group of drawers with electronic locks. This patent also discloses a system that provides usable information for the management of items in the drawers, including the total fee to charge for the medical items dispensed each time. It, however, does not provide the functions of controlling the access and delivery of medical items. In addition, this patented system does not allow multiple users to use the system simultaneously.

U.S. Pat. No. 5,520,450 discloses a computerized medical station including a plurality of dispensing cavities with lockable doors. Individual dispensable items are accessible to authorized persons only. This patented medical station, however, did not provide the function for monitoring the delivery paths to ensure that items dispensed to individual persons are delivered to the corresponding patients. In addition, this medical station is designed for use by only one person at a time.

Other similar systems all provide control and management functions for dispensing of articles; none of them provides the function for monitoring the access and delivery of articles to ensure that the dispensed articles are delivered to the correct receivers through the correct delivery paths. Neither do they provide the necessary hardware equipments to facilitate the delivery. Moreover, there is no local access and delivery control system that allows a plurality of authorized persons to use the system simultaneously, while maintaining the efficiency and correctness of the dispensing operations.

Therefore, it is necessary to develop a computerized local access and delivery control system to control the dispensing and delivery of a great variety of items in particular regions.

It is also necessary to provide a monitored and configurable local access and delivery control system that monitors the delivery paths of a great variety of items, so to correctly deliver the articles.

It is also necessary to provide an integrated local access and delivery control system that integrates the controlling functions into the local dispensing system.

In addition, it is necessary to provide a novel local access and delivery control system that may be used by a plurality of users at the same time.

### OBJECTIVES OF THE INVENTION

An objective of this invention is to provide a computerized local access and delivery control system, to control the dispensing and delivery of a great variety of items in particular regions.

Another objective of this invention is to provide an automated local access and delivery control system that monitors and controls the delivery paths of a great variety of items, so to correctly deliver the items.

Another objective of this invention is to provide a local access and delivery control system that integrates the necessary hardware of controlling devices with the system, so to monitor and control the delivery paths of controlled items and to ensure the correct delivery of the items through correct delivery paths.

Another objective of this invention is to provide a local access and delivery control system that may be used by a plurality of users at the same time.

### SUMMARY OF THE INVENTION

According to the present invention, the local access and delivery control system comprises a control server; at least one specified storage device that includes a plurality of storage cavities, each of which has an access-controlled door controllable by the control server; an ID verification device; and a plurality of mobile units, each of which comprises of a unit control device, a plurality of lockable storage drawers controlled by the unit control device and an ID information pickup device.

In the invented system, the control server is equipped with the capabilities of communicating with each specified storage device and the mobile units controlled by the server. The server is configured to unlock the access-controlled doors of specified storage cavities in the storage device to allow access to the items stored in the cavities by a specified deliverer, after the deliverer has been identified and the deliverer's authorization to access the specified storage cavities has been verified by the server. The server is also configured to unlock a specified lockable storage drawer in the mobile unit used by the authorized deliverer. Also, in the invented system, the control device of the mobile unit (also referred to as the unit control device) is configured to unlock the lockable storage drawer corresponding to a specified receiver, after the receiver is identified of the unit control device.

In one embodiment of this invention, the unit control device is configured to unlock a lockable storage drawer in the mobile unit, only after one particular deliverer is identified. Also in an embodiment, the storage cavities and/or the lockable storage drawers are locked, after the access-controlled doors and/or the lockable storage drawers are closed.

In some embodiments of this invention, the mobile unit is further equipped with an automated (battery) charging device to charge the mobile unit along a pre-determined path or along paths random selected by the control server or an additional automatic (battery) charging control system.

In addition, the control server may include a local personnel information database, to store the personal information, authorizations and other useful information of deliverers and/or receivers of the items in storage devices under the control server's control and management. The control server may also include an inventory database, to store the existing and historical quantity information of the deliverable items in the specified storage device(s) and/or the mobile units.

In most embodiments of this invention, every storage cavity is equipped with an access-controlled door (also referred to as controlled door) to control the access of the items in the storage cavity. In some other embodiments, however, not all storage cavities are equipped with the access-controlled door. In some embodiments, some storage device is further provided with temperature-controlled storage cavities, with their doors being controlled doors or ordinary doors. Similarly, in most embodiments of this invention, all storage drawers of the mobile unit are equipped with the locking function, to control the access of items in the storage drawers. In some other embodiments, however, not all storage drawers are lockable. In some embodiments, the mobile units may be provided with temperature-controlled storage drawers.

The ID verification device is connected to the control server and is configured to identify the IDs of the delivers. The ID verification device may be a reading device, a detection device or an input device. The reading device may be an optical reading device to read the ID information carried by a deliverer, such as barcodes or biometric identification features, such as fingerprint, palm print, iris pattern, facial features etc. The detection device may be a device to detect the ID information carried by a deliverer, such as magnetic card, IC card, RF ID tag etc. The detection may be in a wireless manner. The input device may be a device to accept the input operations of a deliverer and may be a microphone, a keyboard or an image input interface. In the control server, corresponding identification software is installed, to capture the ID information provided by the ID verification device and compare the ID information stored in the personnel information database to determine the identifications of the deliverers and their authorizations. In some embodiments of this invention, the deliverers are further requested to input security information such as passwords, to further ensure correct identification and authorization of each deliverer and correct delivery of the items to be dispensed.

In addition, the control server may be configured to provide a list of items accessible and dispensable at the time to an identified deliverer and deliverable to the mobile unit on which the identified deliverer has logged in.

The unit control device of the mobile unit stores the received list. The list of deliverables may include information on the authorized deliverable items and their corresponding receivers.

The ID information pickup device of the mobile unit is able to pickup the ID information of deliverers and/or receivers. The ID information pickup device may be a reading device, a detection device or an input device. The ID information pickup device is connected the unit control device which verifies the ID of the deliverer and/or the receiver. The reading device may be an optical reading device capable of reading the ID information carried by a deliverer and/or the receiver. Examples include readers of barcodes or biometric identification features, e.g. fingerprint, palm print, iris pattern, facial features etc. The detection device may be a device to detect the ID information carried by a person, such as magnetic card, IC card, RF ID tag etc. The input device may be a device to accept the input operations of a deliverer, such as a keyboard. In the unit control device, corresponding identification software is embedded to grab the ID information obtained by the ID information pickup device and compare the ID information with the ID information obtained from the control server, so to determine the IDs of the deliver and the receiver and the items being delivered. In some embodiments of this invention, the deliverers are further requested to input security information such as passwords, to further ensure correct identification of the deliverer and deliverer's authorization to access the items to be dispensed and delivered.

The unit control device is configured to connect to the control server upon the logging in of a deliverer, so to obtain the corresponding list of deliverable items.

In some embodiments of this invention, the control server provides to each deliverer a plurality of lists of deliverable items, each list for a specified receiver. Information provided by each list includes the ID information of the deliverer, the ID information of receiver and information on the deliverable items in the list. The control server is configured to accept the logging in of a deliverer and the selection of one receiver by the deliverer upon the logging in, followed by unlocking the access-controlled doors of the storage cavities holding items to be delivered to the selected receiver under the collaborative control of the control server and the deliverer. When all the unlocked access-controlled doors are locked again, the control server accepts the deliverer's selection of another receiver from the receivers list and unlocks the access-controlled doors of the storage cavities corresponding to the selected receiver. The same operation continues, until all the receivers corresponding to the deliver are processed.

In most embodiments of this invention, the specified storage device is equipped with display devices, to display information relating to contents in the storage cavities and information relating to the control functions of the system. In such embodiments, all or some of the storage cavities are equipped with individual display devices. In other embodiments, all or some of the storage cavities shares one display device. In addition, in most embodiments of the present invention, the unit control device is equipped with display devices, to display information relating to contents in the lockable storage drawers. In such embodiments, all or some of the lockable storage drawers are equipped with one display device. In other embodiments, all or some of the lockable storage drawer shares one displaying device.

By using a local access and delivery control system having the mechanism, design and functions as described above, deliverable items may be efficiently delivered to the correct receivers. Such a system allows a plurality of deliverers to use each storage device at the same time, without the worry of mistakes and confusions in dispensing and delivering the deliverable items.

Other objectives and advantages of this invention may be clearly understood from the detailed description by referring to the following drawings.

### BRIEF DESCRIPTION OF THE DRAWINGS

FIG. 1 illustrates the systematic diagram of the local access and delivery control system of this invention.

FIG. 2 is the systematic diagram of MUMS (multi-user medication station) as one embodiment of this invention.

FIG. 3 shows the appearance of the medical drawers of the medical cabinet of FIG. 2.

FIG. 4 shows the mobile medical trolleys of the embodiment of FIG. 2.

FIG. 5 is the flowchart of an application of MUMS according to this invention.

### DETAILED DESCRIPTION OF THE INVENTION

The structure, principles and functions of the present invention will be described in details in the followings. It is appreciated that the detailed description and the exemplary embodiments below are provided to illustrate the basic concepts and functions of the present invention. Any one skilled in the art may appreciate the concepts and ideas of the invention and make derivatives or modifications based on such concepts and ideas. All such derivatives and modifications shall belong to the scope of protection of this invention.

The present invention provides a computerized local access and delivery control system, to control the delivery of a plurality of items within a local area and to monitor the delivery paths and situations of the deliverables. This invention also provides a local access and delivery control system that integrates a computerized control system and necessary hardware devices to ensure all deliverables are delivered to correct receivers through correct delivery paths. The invented system can be used by multiple users at a time and contribute in saving resources.

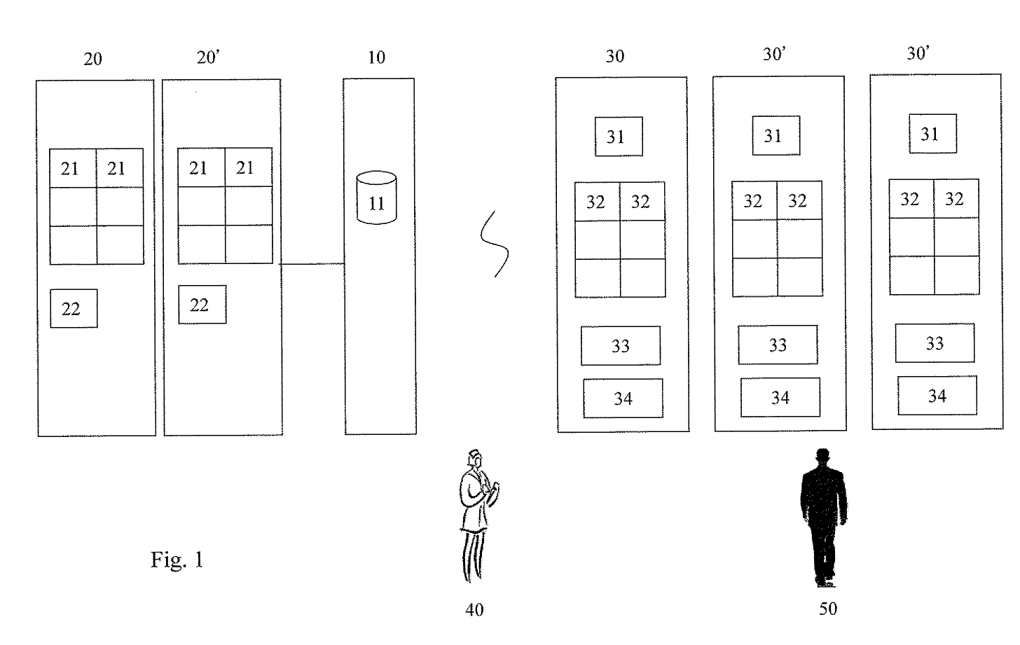

FIG. 1 illustrates the systematic diagram of the local access and delivery control system of this invention. As shown in this figure, the local access and delivery control system of this invention includes a control server 10, at least one storage device 20, 20′ and a plurality of mobile units 30, 30′. In them, the storage devices 20, 20′ each includes a plurality of storage cavities 21, 21, with their access-controlled doors controllable by the control server 10, and at least one ID verification device 22. Each mobile unit 30, 30′ includes a unit control device 31, a plurality of lockable storage drawers 32, 32, controlled by the unit control device 31, and an ID information pickup device 33.

According to the present invention, the control server 10 is equipped with the remote communication capabilities, so to exchange data with the storage devices 20, 20′ and the mobile units 30, 30′. The data communication between the control server 10 and the storage devices 20, 20′ and between the control server 10 and the mobile units 30, 30′ may go through the wired channels or the wireless channels, using the known wired or wireless communication devices and protocols. In the preferable embodiments of this invention, the control server 10 communicates with the storage devices 20, 20′ through the wired channels and with the mobile units 30, 30′ through the wireless channels. This, however, is not any technical limitation.

In the present invention, the control server 10 is equipped with the capabilities for control and management of access and delivery items, such as:

Inventory management functions: Including management of quantities and contents in the specified storage device 20, 20′ and the mobile units 30, 30′ and recordation of their historical information.

Personnel information management functions: Including a personnel information database 11, provided with in the personal ID of a plurality of deliverers and receivers, their authorizations and other useful management information.

Access and delivery control functions: Including verifications in the ID information of the plurality of deliverers and receivers, locking and unlocking of the access-controlled doors of particular storage cavities 21, 21 and particular lockable storage drawers 32, 32 of the mobile units 30, 30′ and recordation of the controlling events.

Alarming functions: Including providing dispensing notices to particular storage device 20, 20′ and/or particular mobile units 30, 30′, generating alarm signals when a wrong dispensing or delivery event is detected and generating alarm signals when a low inventory quantity is detected, etc.

The control server 10 used in this invention may be any server computer, industrial computer, person computer or notebook computer commercially available in the market. The capacity and specifications of the control server 10 may be decided according to the scale of the local area, the number of deliverers/receivers, types and nature of the deliverables etc. The application system provided in the control server 10 to implement this invention may be written in any applicable computer language and installed in the control server 10 for use. According to this invention, no particular software tools or development tools are needed in the development of the application system of this invention. Software engineers with several years of experiences should be able to develop the necessary components of the invented system and complete their integrations in accordance with the description of this invention.

The storage device 20, 20′ is preferably a vertical cabinet. The storage device 20, 20′ is not limited to any size, shape or material, as long as deliverable items may be stored in the storage device 20, 20′ with correct categorizations, with proper enclosure, fully supported and maintained in relative stability.

The storage cavities of the storage device 20, 20′ may be in the form of an ordinary storage box or drawer, security controlled storage box or drawer or temperature-controlled box or drawer. In the case of the ordinary storage box, a door may be provided or not. If a door is equipped, it may be a controlled door. On the other hand, the security-controlled door shall have a door lockable by the control server 10. Such a controlled door is known in the industry. The storage cabinet disclosed in the above-mentioned U.S. Pat. No. 5,520,450 may be used in this invention as the controlled storage cavities after necessary modifications.

As to the temperature-controlled storage boxes or drawer, it is preferably equipped with the heat-isolation function, a shared heater and/or cooler (not shown) and a temperature control device (not shown), to maintain the internal temperature of the storage spaces in a predetermined range. The temperature-controlled storage cavities may be equipped with a controlled door or an ordinary door. The temperature-controlled storage cavities may be implemented by using the commercially available heater and/or cooler and temperature control device, with necessary configurations and installations.

In most embodiments of this invention, however, it is not necessary for the storage device 20, 20′ to include all these 3 types of the storage cavities. In other words, the storage device 20, 20′ may have the ordinary storage box or drawer only, the security controlled storage box or drawer only or the temperature-controlled box or drawer only. It may have only the ordinary and the security-controlled storage boxes or drawers, only the security-controlled and the temperature-controlled storage boxes or drawers or only the temperature-controlled and the ordinary boxes or drawers. In the case of a hospital, the storage for storing precious items, the weapon storage or other similar applications, it is preferable that only the security-controlled and the temperature-controlled storage boxes or drawers are used.

To correctly deliver the deliverables, the storage device 20, 20′ is provided with at least one ID verification device 22, connectable to the control server 10 for purpose of correctly identifying the deliverers 40. The ID verification device 22 may include a reading device, a detection device or an input device. In the case of a reading device, it may be an optical reading device to read the ID information carried by a deliverer, such as barcodes or biometric identification features, e.g. fingerprint, palm print, iris pattern, facial features etc. Therefore, it may be a barcode reader, an optical scanner etc. In the case of a detection device, it may be a device to wiredly or wirelessly detect the ID information carried by a deliverer, such as magnetic card, IC card, RF ID tag etc. Therefore, it may be a card reader, card detector, RF detector etc. In the case of an input device, it may be a device to accept the input operations of a deliverer, such as a microphone, a keyboard or an image input interface. In the control server, corresponding identification software is embedded to obtain the ID information provided by the ID verification device 22 and compare the ID information with the ID information stored in the personnel information database 11, to determine the identification of the deliverers and their authorizations. These devices or tools may be easily implemented by using the commercially available products.

The control server 10 is configured to unlock the access-controlled doors of storage cavities corresponding to a particular deliverer, after the deliverer is identified. That is, the storage cavities wherein the deliverable items authorized to the identified deliverer are stored and unlocked. In some embodiments of this invention, the control server 10 is configured to relock the unlocked storage spaces, after the deliverable items have been removed from the storage spaces. In other embodiments, the control server 10 is configured to relock an unlocked storage cavity, after its door is closed.

In addition, the control server 10 is configured to provide, upon the identification of an authorized deliverer, a list of deliverables corresponding to the deliverer, which includes descriptions in the items and quantity of the deliverables and the ID information of the their corresponding receivers, to the mobile unit 30 in which the deliverer 40 has logged in. In response, the mobile unit 30 stores the received list of deliverables in its unit control device 31 for later use.

In the embodiment of this invention, the mobile units 30, 30′ may be in the form of a trolley, equipped with a plurality of casters, so that the deliverer may easily move the mobile unit 30 to the desired destinations. This, however, is not any technical limitation. Any carrier with or without driving power may be used as the mobile unit of this invention. In the mobile unit 30 a plurality of storage drawers 32, 32 is provided. There are no particular limitations in the material, size and shape of the trolley and the storage drawers. Preferably, the mobile unit 30 is made light and compact, so to move easily.

Similar to the storage device 20, 20′, each mobile unit 30, 30′ is provided with a plurality of storage drawers 32, 32. The storage drawers 32, 32 may include the ordinary storage drawers, the security-controlled storage drawers and/or the temperature-controlled storage drawers. In most applications, the major function of the storage drawers 32, 32 is to temporarily preserve the deliverables; therefore the ordinary storage drawer would suffice. However, in other applications, certain security-controlled storage drawers and/or temperature-controlled storage drawers may be additionally provided. In some particular embodiments, all the 3 types of the storage drawers are all provided.

In order to deliver the deliverables to correct receivers 50, the mobile unit 30, 30′ is provided an ID information pickup device 33, connectable to the unit control device 31, to verify the identity of the delivers 40 and the receivers 50. The ID information pickup device 33 may be a reading device, a detection device or an input device. In the case of a reading device, the ID information pickup device 33 may be a barcode reader or an optical reading device that reads the biometric identification features. Considering the mobility of the mobile unit 30, the ID information pickup device 33 is preferable a barcode reader, while in other applications, the ID information pickup device 33 may also be a detection device or an input device. In the case of a detection device, the ID information pickup device 33 may be a device to detect the ID information carried by a person, such as magnetic card, IC card, RF ID tag etc., through the wired or wireless communication channels. In the case of an input device, the ID information pickup device 33 may be a device to accept the input operations of a deliverer, such as a keyboard. In the unit control device 31, corresponding identification software is embedded to obtain the ID information provided by the ID information pickup device 33 and compare the ID information with the list of ID information in the deliverable list obtained from the control server 10, so to verify the ID of the delivers 40 and the receivers 50 and the contents being delivered.

The unit control device 31 may be implemented using a commercially available computer device, such as a personal computer, a notebook computer or an industrial computer. The unit control device 31 shall be provided with the communication capabilities, to connect and exchange data with the control server 10, through the wired or the wireless communication channels. The unit control device 31 is software configured to connect the control server 10 upon the logging in of a deliverer 40 through the ID information pickup device 33, to obtain the list of deliverables corresponding to the deliverer. In the embodiments of this invention, the unit control device 31 is configured to unlock at least one of the plurality of storage drawers 32, 32 in response to the selection or input operation of the representative code or other information corresponding to a receiver by the deliverer, so to allow the deliverer 40 to place the corresponding deliverables in the unlocked storage drawer. In such embodiments, the mobile unit 30 may be equipped with a displaying device 34, to display the list of deliverables for the deliverer 40 to select.

In some embodiments of this invention, the unit control device 31 is additionally configured to relock the unlocked storage drawer, when the storage drawer is closed.

In most embodiments of this invention, each storage cavity 21, 21 is provided a displaying device 23, 23, to display information relating to the contents in the storage cavity 21, 21 and other useful information. In other embodiments, however, not all storage cavities are provided with one displaying device 23. In further other embodiments, all or a part of the storage cavities shares one displaying device 23. Similarly, in most embodiments of this invention, each storage drawer 32, 32 is provided a displaying device 34, 34, to display information relating to the contents in the storage drawer 32, 32 and other useful information. In other embodiments, however, not all storage drawers are provided with one displaying device 34. In further other embodiments, all or a part of the storage drawers shares one displaying device 34.

In addition, in most embodiments of this invention, each storage cavity 21, 21 is provided a controlled door, to control the access of the items stored therein. In other embodiments, however, not all storage spaces are provided with the controlled door. In further other embodiments, only the security-controlled storage cavities and the temperature-controlled storage cavities are provided with the controlled door. Similarly, in most embodiments of this invention, all storage drawers 32, 32 are lockable, in order to control the access of the items stored therein. In other embodiments, however, not all storage drawers are lockable.

The mobile unit 30, 30′ may be further equipped with an automated charging device (not shown), to be controlled by the control server 10 or an additional automatic charging control device and to move the mobile unit 30, 30′ along predetermined paths or randomly selected paths. The automated charging device may be any commercially available robot and automatically carries the mobile unit 30 to travel within a factory, a community, a campus, a hospital, an organization or a military base.

In the application of this invention, the control server 10 will obtain a list of deliverables effective for a predetermined period of time from an external application system (not shown), such as a production management system, a medical items management system, a munitions management system, a merchandise management system, a logistic system etc. The deliverable list would include information such as names, codes and quantity of deliverable items and the ID information of their corresponding deliverers and receivers. The ID information of the deliverers relates to the respectively corresponding mobile units.

When a deliverer 40 logs in a particular mobile unit 30, the mobile unit 30 picks up the ID information of the deliverer 40. After verification, the ID information and the log-in status are provided to the control server 10. In response, the control server 10 transfers the list of deliverables corresponding to the deliverer 40 to the mobile unit 30. In the deliverable list, provided is information relating to the items and quantity of the deliverables and their corresponding receivers. Upon receipt of the deliverable list, the mobile unit 30 displays the deliverable items and their quantity in the displaying device 34 of the mobile unit 30 or of the respective storage drawers 32, 32, in the order of their corresponding receivers.

To claim the deliverable items, the deliverer logs in the storage device 20, in person or using a mobile unit, whereby the storage device 20 notifies the control server 10 the log-in status of a deliverer/mobile unit pair. In response, the control server 10 provides the list of deliverables corresponding to the deliverer to the storage device 20. In the deliverable list, provided is information including the receivers, items and quantity of deliverables corresponding to the deliverer, based on the data stored in the personnel information database 11.

When the storage device 20 receives the deliverable list, it notifies the unit control device 31, which then generates an alarm signal and displays a notice in the displaying device 34, to remind the deliverer 40 to select a receiver from the list of receivers. After receiving the selection instruction of the deliverer 40, the control server 10 generates instructions to instruct the mobile unit 30 to unlock a storage drawer 32 corresponding to the selected receiver. The control server 10 also instructs the storage device 20 to unlock the storage cavities 21 wherein deliverable items corresponding to the selected receiver are stored and to display names of the deliverable items and the selected receiver in the displaying device 23. Here, there may be more than one storage cavities to be unlocked. They may be unlocked simultaneously or in a predetermined or a randomly determined order.

At this time point, and before a predetermined deadline, the deliverer 40 is allowed to open the door of the storage cavities being unlocked at a time or in order, to remove the authorized items from the storage spaces. When the deliverer 40 closes the door of the storage cavities 21, 21, the control unit 10 determines all the deliverable items in the authorized quantity have been removed from the storage cavities 21, 21 and placed in the storage drawer 32 of the mobile unit 30. It then commences the same dispensing operations for the next selected receiver, until all the receivers are processed. In some embodiments of this invention, a correction program is provided, whereby the deliverer may return excessive deliverable items or request additional deliverable items, when mistakes in the contents or quantity of the deliverable items are found.

When the mobile unit 30 is moved to adjacent to a receiver 50, the deliverer 40 or the receiver 50 may use the ID information pickup device 33 of the mobile unit 30 to input the ID information of the receiver 50. After verification, the mobile unit 30 unlocks the storage drawer 32 corresponding to the receiver, allowing the deliverer 40 or the receiver 50 to remove the items stored therein, to complete one delivery. In some embodiments of this invention, the deliverers 50 are further requested to input security information such as passwords, to further ensure correct delivery of the items to be delivered.

### Embodiment

In the followings, an example for using the local delivery control system of this invention in a hospital will be given to illustrate the system, application and functions of the present invention.

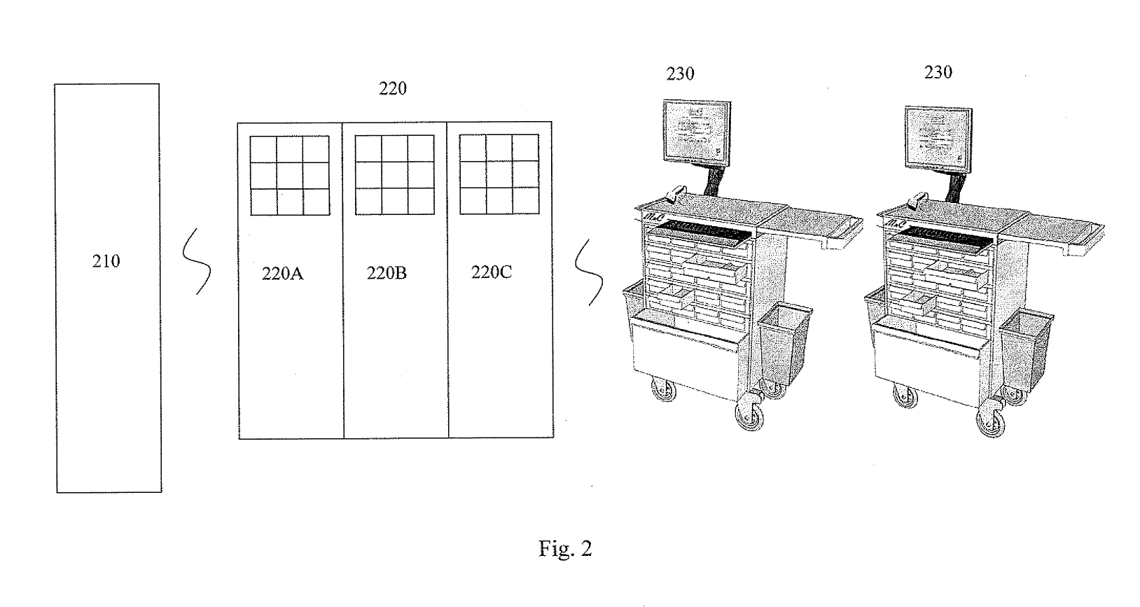

To demonstrate the structure, components, application and functions of this invention, a multi-user medication station (MUMS) to be used in a hospital is prepared. FIG. 2 is the systematic diagram of the MUMS. As shown in this figure, the MUMS includes an MUMS server 210, a multi-user medical cabinet 220 and a plurality of medicine trolleys 230, 230. In them:

1. The multi-user medical cabinet 220: In this embodiment, the storage device 20 is a multi-user medical cabinet 220. As shown in this figure, the multi-user medical cabinet 220 has a plurality of drawers, which are divided into a group of ordinary drawers 220A, a group of security-controlled drawers 220B and a group of refrigerator drawers 220C.

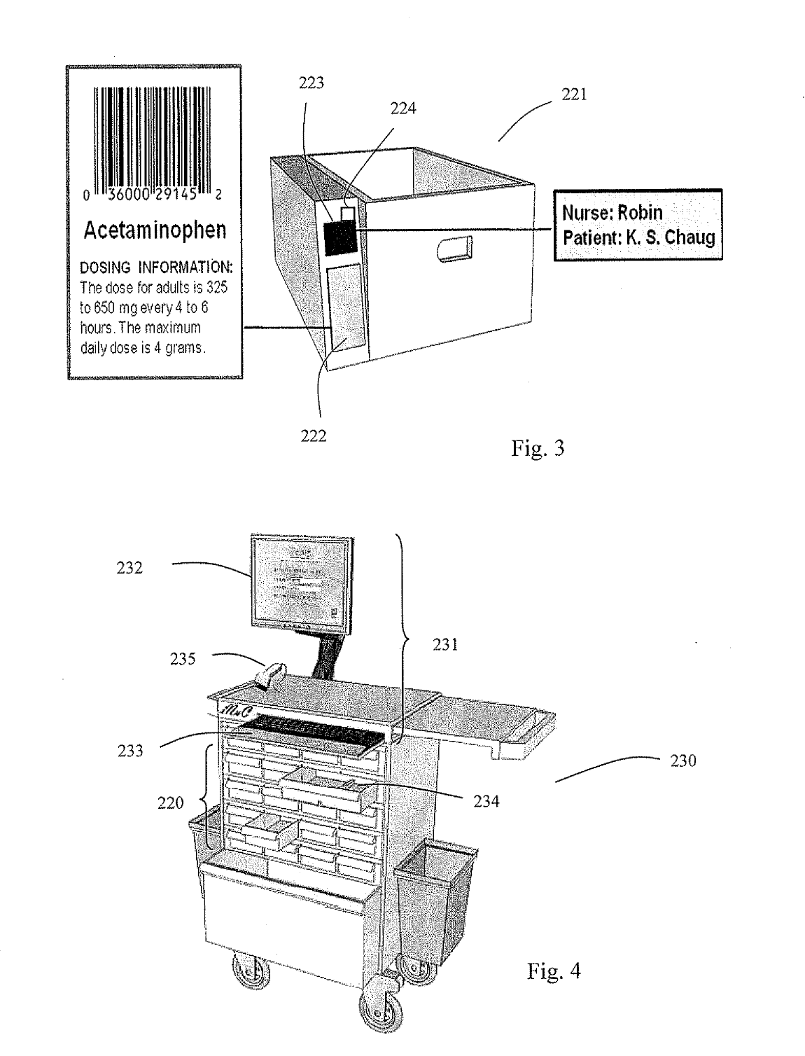

FIG. 3 shows the appearance of the medical items drawers of the medical cabinet 220. In the figure, each drawer 221 has a tag 222 in which name of medical items stored therein is described. In the tag 222, in addition to the name of the medical items and other useful information, a machine-readable code 225, which may be a barcode or an RFID, is provided. In addition, a small-scaled LCD 223 is provided to display useful information, such as name of the authorized nurse, remaining quantity of medical items etc. An LED light 224 is also provided to indicate the drawers where the deliverable items are stored to the nurse. Inside the security-controlled drawers a detector (not shown) is provided to monitor the storage conditions of the expensive or controlled medical items therein.

All drawers have an electric lock, controlled by the MUMS server 10.

2. The MUMS server 210: The MUMS server 210 includes a personal computer or a server, with or without a displaying screen. The MUMS server 210 is connected to the main server (not shown) of the hospital via a local area network, to obtain doctor prescriptions from the main server and to record the historical data of the inventory of medical items in the medical cabinet 220. The MUMS server 210 functions as the intermediator of the mobile medicine trolleys 230 and the medical cabinet 220. The MUMS server 210 communicates with a plurality of medical cabinets 220 via the wireless network or the local area network and locks and unlocks the medical drawers of these medical cabinets 220. The communication and data transmission between the MUMS server 210 and the mobile medical trolleys of the respective nurses go through the wireless network.

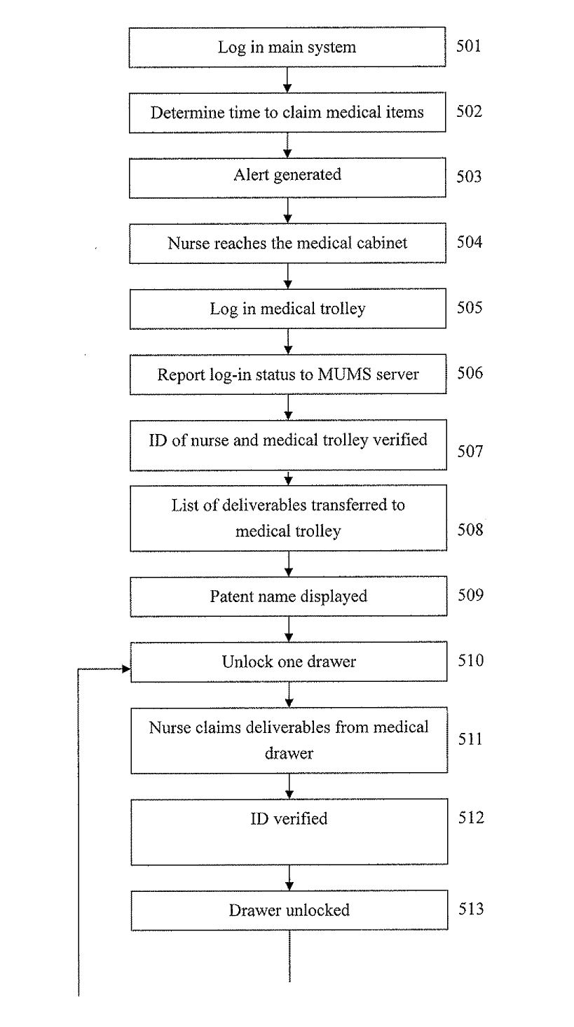

3. The medical trolleys (the mobile units): The medical trolleys 230 are mobile trolleys to carry medical items and work with the controlled operations of the medical cabinets 220. FIG. 4 shows the medical trolleys of this embodiment. As shown in the figure, a medical trolley 230 includes 3 major modules: A control machine 231, a group of storage drawers 234, 234 and a reading device 235. The control machine 231 may be a personal computer or an embedded system, equipped with a screen 232 and a keyboard 233, or simply a touch screen (not shown), to be operated by the nurses. The control machine 231 is installed with an application system in accordance with this invention. The group of storage drawers 234, 234 is locked and unlocked by the control machine 231. Without authorization, the nurse can not open the drawers. The reading device 235 may be a barcode reader or an RFID detector. It reads the representative code 225 on the tag 222 of the storage drawers 234, 234 and the identification tag worn on the wrist of the patients (receiver) and provides the obtained information to the control machine 231 via the wired or wireless communication channels.

In the followings, one example of the applications of the MUMS will be given. It is appreciated that the applications of the invented MUMS are not limited to this and similar examples. In this example, barcodes are used as the ID information of the medical items and the patients.

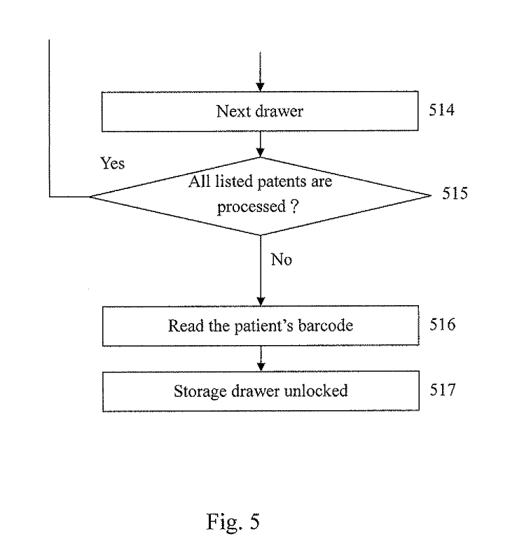

FIG. 5 is the flowchart of one exemplary application of the MUMS of this invention. As shown in this figure, in step 501 the time is 8:00 am and Nurse Robin begins her duty in the hospital. She uses the personal computer at the medical station or the medical trolley 230 to log into the main system of the hospital. At step 502 the main system determines that at 9:00 am Robin shall claim medical items for her patients from the medical cabinet 220 located in the floor where she works, therefore, in step 503, at 8:55 the main system reminds Robin to claim the medical items by sending a short message to Robin or by broadcasting.

At step 504 Robin reaches the designated medical cabinet 220 with medical trolley No. 4, after she received the reminder at 8:55 am. The medical cabinet 220 is one of the medical cabinets in connection with the MUMS. At the same time, many other nurses also come to the same medical cabinet 220 to claim medical items for their patients. At step 505 Robin logs in her medical trolley No. 4 and pushes the “claim medical items” key. At 506 the medical trolley 230 reports to the MUMS server 210 of the log-in status via the wireless network. In response, at step 507 the MUMS server 210 verifies the identification of Robin and the medical trolley No. 4 and transfers the list of deliverables authorized to Robin at this time to the medical trolley No. 4 at step 508.

At 509 the medical trolley No. 4 displays the names of the patents that Robin takes care and unlocks one of the storage drawers 234 at step 510, after Robin selects one patient from the patient list. When Robin has taken all the medical items that she is authorized to deliver to the selected patient from the medical cabinet 220, she stores the medical items in the unlocked drawer 234. After she closes the drawer 234, the drawer 234 cannot be opened until the barcode worn at the wrist of the selected patient is read by the reading device 235. Also at step 510, the medical items to be delivered to the selected patient, as well as the location of the cabinet 220 and the medical drawers 221 where the medical items are stored, will also be displayed. In addition, the small-scaled LCD of these medical drawers 221 will display Robin's name and/or the LED light in these medical drawers 221 will blink or change colors, to indicate to Robin the locations of the deliverables. At this time, more than one nurse may also be authorized to take medical items from the same medical drawers 221. Therefore, in the LCD of these medical drawers 221, the names of more than one nurse are displayed and/or the LED generates lights in more than one color.

At step 511, Robin approaches to one medical drawer 221 on which her name is displayed and uses the barcode reader 235 to read the barcode on the medical drawer 221. The information of the read barcode is transferred to the medical trolley No. 4, which in turn transfers the information to the MUMS server 210 for verification. At step 512 the MUMS server 210 verifies the obtained information and unlocks this particular medical drawer 221 at step 513, to allow Robin to take the authorized medical items out of this medical drawer 221 after she opens the drawer. At the same time, many other nurses are also claiming medical items from the same medical cabinet 220, from the same or different medical drawers. This feature is the “multi-user” function of this invention and is different from the existing systems where only one nurse is allowed to claim medical items at one time.

At step 514 Robin moves to a second medical drawer to claim medical items, after she has taken out the authorized medical items from the first medical drawer. After all the medical items to be delivered to the selected patient are all obtained, Robin stores them in the unlocked storage drawer 234 of the medical trolley No. 4 and closes the drawer 234. At step 515 the control machine 210 determines whether all the listed patents are processed. If yes, an alarm is generated to remind Robin to repeat steps 510-514, until all the listed patients are processed.

Thereafter, Robin moves the mobile medical trolley to the ward where she works. At step 516 Robin uses the barcode reader to read the barcode worn at the wrist of one patient. At step 517 the control machine 231 verifies the read information and unlocks the storage drawer corresponding to this patient, leaving the other storage drawers locked. As a result, the medication is delivered to the correct patient.

As described above, the local delivery control system of this system provides a novel mechanism to deliver items to correct receivers in a local area. The invented system is a multi-user system and ensures the correct and efficient delivery of deliverables. The present invention also successfully integrates the computerized control system and the resources storage and delivery system into one system. In addition, this invention simplifies the resources delivery and control procedures of the existing technology.

Although in the description of the invention, the example of an MUMS is given, this invention is applicable in many fields where local dispensing/delivery of resources is needed. For example, this invention may be used in all factories, organizations, military institutions, enterprises, communities etc.

As the present invention has been shown and described with reference to preferred embodiments thereof, those skilled in the art will recognize that the above and other changes may be made therein without departing form the spirit and scope of the invention.

What is claimed is:

1. A local delivery control system, comprising:
a control server;
at least one storage device, including a plurality of storage cavities with access-controlled doors controllable by the control server and an ID verification device; and
a plurality of mobile units, each comprising a unit control device, a plurality of lockable storage drawers controlled by the unit control device and an ID information pickup device;
wherein the control server has the capabilities of communicating with the storage device and the mobile units and is configured to unlock the access-controlled doors of the storage cavities corresponding to a particular deliverer, after the deliverer is identified, and to unlock the a corresponding lockable storage drawer in the mobile unit; and
wherein the unit control device is configured to unlock one lockable storage drawer corresponding to a receiver, after the receiver is identified.

2. The system according to claim 1, wherein the unit control device is configured to unlock a lockable storage drawer in the mobile unit, only when one particular deliverer is identified.

3. The system according to claim 1, wherein the storage cavities and the lockable storage drawers are locked, after the access-controlled doors and the lockable storage drawers are closed.

4. The system according to claim 1, wherein the mobile unit further comprises an automated charging device, to charge the mobile unit along a predetermined path or randomly determined paths.

5. The system according to claim 1, wherein the control server further comprises a personnel information database, to store the personal information, authorizations and other useful information of deliverers and receivers of the items to be delivered.

6. The system according to claim 1, wherein the control server further comprises an inventory database, to store inventory information and historical inventory information of items to be delivered in the storage device and the mobile units.

7. The system according to claim 1, further comprising temperature-controlled storage cavities in the storage device.

8. The system according to claim 1, further comprising temperature-controlled storage drawers in the mobile unit.

9. The system according to claim 1, wherein the ID verification device comprises at least one selected from the group consisted of a reading device, a detection device and an input device.

10. The system according to claim 9, wherein the reading device optically obtains ID information carried by the deliverer in the form of at least one selected from the group consisted of barcode, fingerprint, palm print, iris pattern and facial features.

11. The system according to claim 9, wherein the detection device obtains ID information carried by the deliverer in the form of at least one selected from the group consisted of magnetic card, IC card and RF ID tag.

12. The system according to claim 1, wherein the control server is configured to provide a list of deliverables in correspondence with an identified deliverer to the mobile unit that the identified deliverer has logged in; and wherein the list of deliverables includes information representing items deliverable by the deliver and their corresponding receivers.

13. The system according to claim 1, wherein the ID information pickup device comprises at least one selected from the group consisted of a reading device, a detection device and an input device.

14. The system according to claim 13, wherein the reading device optically obtains ID information carried by the deliverer in the form of at least one selected from the group consisted of barcode, fingerprint, palm print, iris pattern and facial features.

15. The system according to claim 13, wherein the detection device obtains ID information carried by the deliverer in the form of at least one selected from the group consisted of magnetic card, IC card and RF ID tag.

16. The system according to claim 1, wherein the unit control device is configured to connect the control server upon the logging in of a deliverer and to obtain from the control server a list of deliverables corresponding to the deliverer, wherein the list of deliverables provides the ID information of deliverers, the ID information of receivers corresponding to the respective deliverers and descriptive information representing deliverables corresponding to the respective receivers.

17. The system according to claim 1, wherein the control server is configured to:
accept the logging in of a deliverer; unlock particular storage cavities corresponding to a first receiver, after the deliverer selects the first receiver; determine whether all receivers corresponding to the deliverer are processed; if the determination is negative, repeat the preceding 2 steps; and if the determination is positive, stop the process.

18. The system according to claim 1, wherein the storage device further comprises displaying devices to display information relating to contents in the storage cavities and information relating to controlling functions of the system.
